(19) United States
(12) Patent Application Publication
(10) Pub. No.: US 2025/0377037 A1
(43) Pub. Date: Dec. 11, 2025

(54) BIMINI TOP ACTUATOR

(71) Applicant: NORCO INDUSTRIES, INC., Compton, CA (US)

(72) Inventors: Bernard F. GARCEAU, Vandalia, MI (US); Jeff LONG, Compton, CA (US)

(21) Appl. No.: 19/220,911

(22) Filed: May 28, 2025

Related U.S. Application Data
(60) Provisional application No. 63/658,272, filed on Jun. 10, 2024.

(51) Int. Cl. F16H 37/12; B63B 17/02

(52) U.S. Cl. CPC F16H 37/122; B63B 17/02

(57) ABSTRACT

A bimini top is disclosed that includes a frame comprising a first support arm and a second support arm and an actuator comprising a housing, a first link arm coupled to the first support arm and rotatably coupled to the housing, a second link arm coupled to the second support arm and rotatably coupled to the housing, a drive carriage movable within the housing between a first position and a second position, and a motor to drive the drive carriage between the first and second positions. The first and second link arms are rotatable relative to the housing based on the drive carriage moving between the first and second positions.

### CROSS-REFERENCE TO RELATED APPLICATIONS

This application claims priority to and the benefit of U.S. Provisional Patent Application No. 63/658,272, filed 10 Jun. 2024, titled “BIMINI TOP ACTUATOR”, the disclosure of which is hereby incorporated by reference in its entirety.

### FIELD OF THE DISCLOSURE

The present disclosure relates generally to boats and, more particularly, to systems and methods for controlling the position of a bimini top of a boat.

### BACKGROUND OF THE DISCLOSURE

Most bimini top structures consist of an articulating metal frame that has anywhere from two to four points of contact on both the starboard and port side of the boat. These folding metal structures support a foldable cloth cover that forms a temporary shade over the boat's cockpit. These structures may be deployed manually from a stored position on the aft deck of a watercraft to an erected or “deployed” position above the cockpit of the boat. Some boats may include a bimini top that can be transitioned between the stored and deployed states using hydraulic drives or electric motor drives. Conventions powered bimini tops, however, generally require many moving parts that make them susceptible to wear, expensive to manufacture, and less reliable. Moreover, these conventional bimini tops may be driven by a gear coupled to a frame of the bimini, which can further increase manufacturing costs and complexity, such as by requiring more durable materials to withstand increased wear. Additionally, bimini tops driven by a gear with a single point of contact require more precise alignment, especially if the bimini is raised and lowered with two separate gear assemblies. Furthermore, gear assemblies with one point of contact to the frame of a bimini have a low load capacity and efficiency, high risk of tooth failure, and experience increased vibration and noise. Accordingly, there is a need for systems and methods for more efficiently controlling a position of bimini tops.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Any combinations of the various embodiments and implementations disclosed herein can be used in a further embodiment, consistent with the disclosure. These and other aspects and features can be appreciated from the following description of certain embodiment as presented herein in accordance with the disclosure and the accompanying drawings and claims.

### BRIEF DESCRIPTION OF THE DRAWINGS

FIG. 1A is a perspective view of a boat having a bimini top in a deployed position and a system including first and second actuators for controlling a position of the bimini top, according to at least one aspect of the present disclosure.

FIG. 1B is a side view of a portion of the boat and the system of FIG. 1A, according to at least one aspect of the present disclosure.

FIG. 2 is a perspective view of a frame of the bimini top of FIGS. 1A and 1B and the first and second actuators of the system of FIGS. 1A and 1B, according to at least one aspect of the present disclosure.

FIG. 3 is a partial side view of the boat and system of FIG. 1A with the bimini top in a stowed position, according to at least one aspect of the present disclosure.

FIG. 4 is an exploded via of the first actuator of FIG. 1A that includes first and second link arms, according to at least one aspect of the present disclosure.

FIG. 5 is side view of the actuator of FIG. 4 with the first and second link arms in their respective stowed positions, according to at least one aspect of the present disclosure.

FIG. 6 is side view of the actuator of FIG. 4 with the first and second link arms in their respective intermediate positions, according to at least one aspect of the present disclosure.

FIG. 7 is side view of the actuator of FIG. 4 with the first and second link arms in their respective deployed positions, according to at least one aspect of the present disclosure.

FIG. 8A is a cross-sectional side view of another actuator for use with the bimini top of FIGS. 1A and 1B, in accordance with at least one aspect of the present disclosure.

FIG. 8B is a side view of the actuator of FIG. 8A when assembled with a locking pin, in accordance with at least one aspect of the present disclosure.

FIG. 9 is a cross-sectional side view of the actuator of FIG. 8A in a radar configuration with the locking pin removed, in accordance with at least one aspect of the present disclosure.

FIG. 10 is a partial side view of the boat of FIG. 1A with a bimini top thereof placed in a stowed position by a pair of actuators of FIG. 8A, in accordance with at least one aspect of the present disclosure.

FIG. 11 is a partial side view of the boat of FIG. 10 with the bimini top placed in a radar position by the pair of actuators, in accordance with at least one aspect of the present disclosure.

FIG. 12 is a perspective view of another boat having a bimini top in a deployed position and a system including first and second actuators for controlling a position of the bimini top, according to at least one aspect of the present disclosure.

FIG. 13 is a perspective view of the boat of FIG. 12 with the bimini top in a radar position, according to at least one aspect of the present disclosure.

FIG. 14 is a perspective view of a frame of the bimini top of FIG. 12, in accordance with at least one aspect of the present disclosure.

FIG. 15 is a perspective view of the first actuator of FIG. 12 that includes first and second link arms, in accordance with at least one aspect of the present disclosure.

FIG. 16 is a perspective view of the first actuator of FIG. 15 omitting portions of a housing thereof, in accordance with at least one aspect of the present disclosure.

FIG. 17 is a cross-section side view of the first actuator of FIG. 12 with the first and second link arms in a stowed position, in accordance with at least one aspect of the present disclosure.

FIG. 18 is a cross-section side view of the first actuator of FIG. 12 with the first and second link arms in a radar position, in accordance with at least one aspect of the present disclosure.

FIG. 19 is a cross-section side view of the first actuator of FIG. 12 with the first and second link arms in a deployed position, in accordance with at least one aspect of the present disclosure.

FIG. 20 is a block diagram of a control system for controlling the actuators disclosed herein, in accordance with at least one aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a bimini top actuator and, more particularly, to a system for deploying a bimini top of a boat.

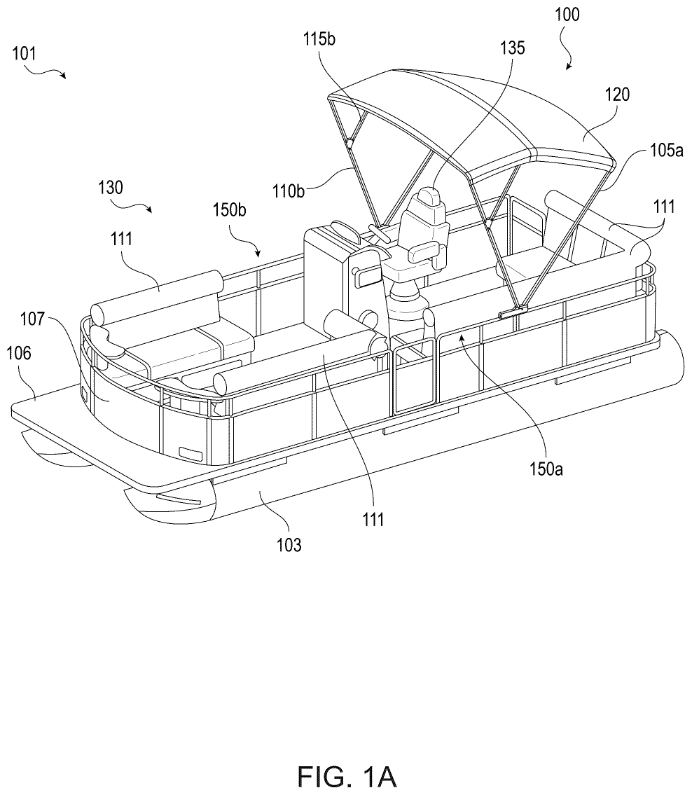

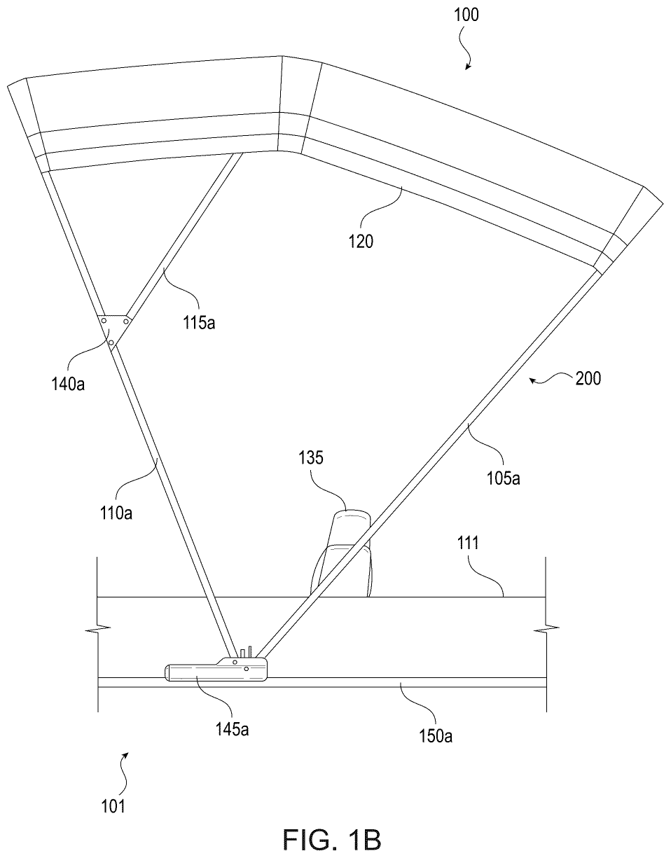

FIG. 1A is a perspective view of a boat 130 having a system 101 for controlling a position a bimini top 100 of the boat 130, according to at least one aspect of the present disclosure. The boat 130 may include a pair of hulls 103, a deck 106 arranged on the hulls 103, and a railing 107 mounted on at least a portion of the deck 106. The railing 107 may extend upward from an upper surface of the deck 106, opposite the hull 103, and include at least a port side railing 150a and a starboard side railing 150b. In the illustrated embodiment, the boat 130 is a pontoon boat; however, the principles of the present disclosure are applicable to other types of boats, such as fishing boats, deck boats, or the like. The boat 130 may further include benches 111 on the deck 106, inward of, and boarding, the railing 107. The boat 130 may further include a cockpit or a chair 135 on the deck 106.

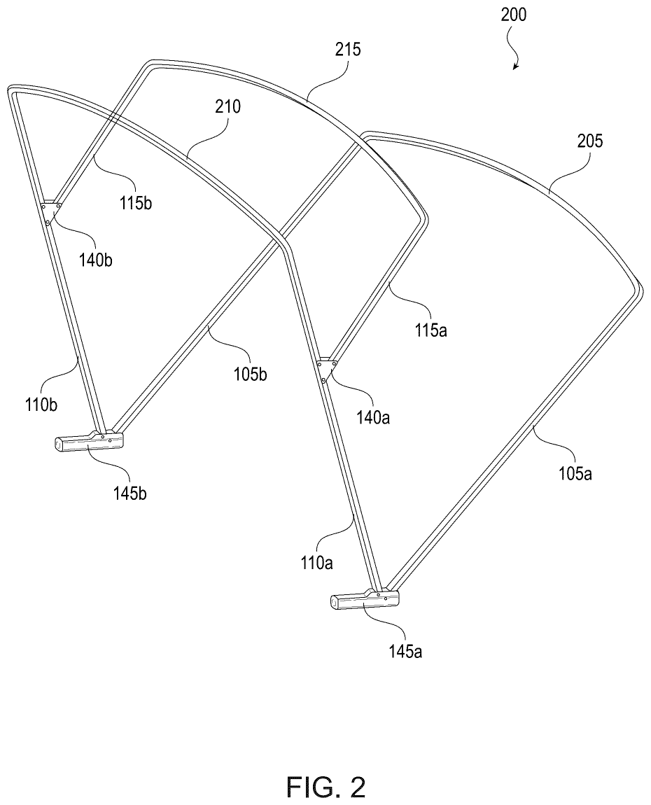

With reference to FIGS. 1B and 2, the bimini top 100 may include a frame 200 that includes rear support arms 105a,b, front support arms 110a,b, and middle support arms 115a,b, which collectively support a canvas or “cover” 120 of the bimini top 100.

The rear support arms 105a,b may be coupled together via a rear support member or “rear support” 205. The rear support arms 105a,b and the rear support 205 may be of unitary construction or may be separate pieces mechanically fastened together. Similarly, the front support arms 110a,b can be coupled together via a front support member or “front support” 210. The front support arms 110a,b and the front support 210 may be of unitary construction or may be separate pieces mechanically fastened together. Similarly, the middle support arms 115a,b can be coupled together via a middle support member or “middle support” 215 that may be positioned within a pocket of the cover 120. The middle support arms 115a,b and the middle support 215 may be of unitary construction or may be separate pieces mechanically fastened together.

The frame 200 may further include brackets 140a,b for coupling the middle support arms 115a,b to the front support arms 110a,b, respectively. The brackets 140a,b may allow the middle support arms 115a,b to move relative to the front support arms 110a,b.

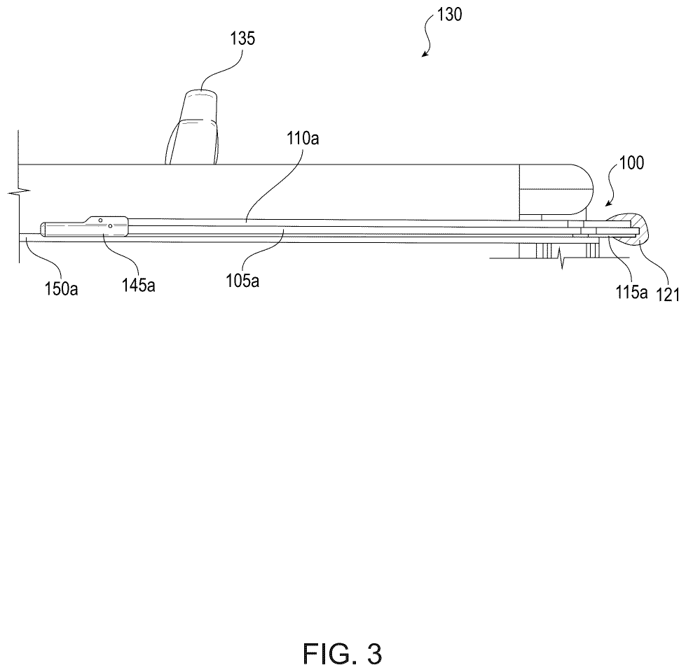

The bimini top 100 may be transitionable between a first or “deployed” position, as shown in FIGS. 1A, 1B, and 2, and a second or “stowed” position, as shown in FIG. 3. In the deployed position, the cover 120 of the bimini top 100 may provide cover from external elements (e.g., rain and/or sunlight) to occupants of the boat 130. In the stowed position, the rear support arms 105a,b, the front support arms 110a,b, and the middle support arms 115a,b may each be collapsed to a horizontal, or at least substantially horizontal position, relative to the deck 106. In the stowed position, the cover 120 may be covered or enclosed in a sleeve, cover, or wrap 121, alternatively referred to as a “boot” to protect the cover 120. In the stowed position, the frame 200 may surround the stern of the boat 130.

The system 101 may include a first or “port side” actuator 145a and a second or “starboard side” actuator 145b. The rear support arm 105a and the front support arm 110a may be coupled to the first actuator 145a, while the rear support arm 105b and the front support arm 110b may be coupled to the second actuator 145b. As will be described in more detail below, the first and second actuators 145a,b are operable to drive the rear and front support arms 105a,b, 110a,b to transition the bimini top 100 between the stowed and deployed positions. The first actuator 145a may be mounted to the side rail 150a and the second actuator 145b may be mounted to the side rail 150b. Alternatively, the actuators 145a,b may be coupled to another part of the boat 130, such as the deck 106.

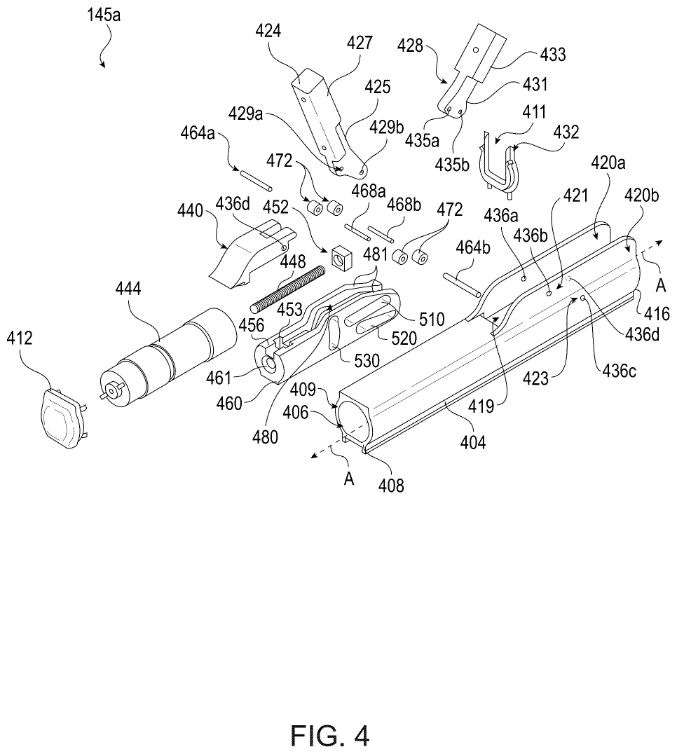

FIG. 4 illustrates an exploded view of the first actuator 145a, according to one or more embodiments of the present disclosure. While the following discussion is provided with respect to the first actuator 145a, the second actuator 145b is the same, or substantially the same, construction and, thus, the following discussion is equally applicable to the second actuator 145b.

The actuator 145a may include a housing 404 that includes a front end 408 and a back end 416 opposite the front end 408. The housing 404 may define a cavity 406 that extends through the housing 404 along an axis A from the front end 408 to the back end 416. The housing 404 may be machined from a metal extrusion, such as aluminum, steel, titanium, or alloy. The front end 408 of the housing 404 may define a first or “front” opening 409 that is in communication with the cavity 406. A front end cap 412 may be coupled to the housing 404 to cover the opening 409, thereby protecting internal components of the actuator 145a.

The housing 404 may further define a second or “top” opening 419 that is in communication with the cavity 406. The housing 404 may further define, or otherwise provide, first and second fins 420a,b that extend on opposing sides of the opening 419. The first fin 420a may define a first aperture 436a and the second fin 420b may define a second aperture 436b aligned with the first aperture 436a. The housing 404 may further define a third aperture 436c on a first lateral side of the housing 404 that is vertically and horizontally offset from the first aperture 436a and that is positioned closer to the back end 416 compared to the first aperture 436a. The housing 404 may define a fourth aperture 436d (shown in phantom) on a second lateral side of the housing 404, opposite the first lateral side. The fourth aperture 436d may be aligned with the third aperture 436c, vertically and horizontally offset from the second aperture 436b, and may be positioned closer to the back end 416 compared to the second aperture 436b.

The housing 404 may include a cover top 440 that may be arranged between at least a portion of the fins 420a,b to protect the internal components of the actuator 145a. The cover top 440 may define an aperture 436d that may be aligned with the first and second apertures 436a,b based on the cover top 440 being received between the fins 420a,b.

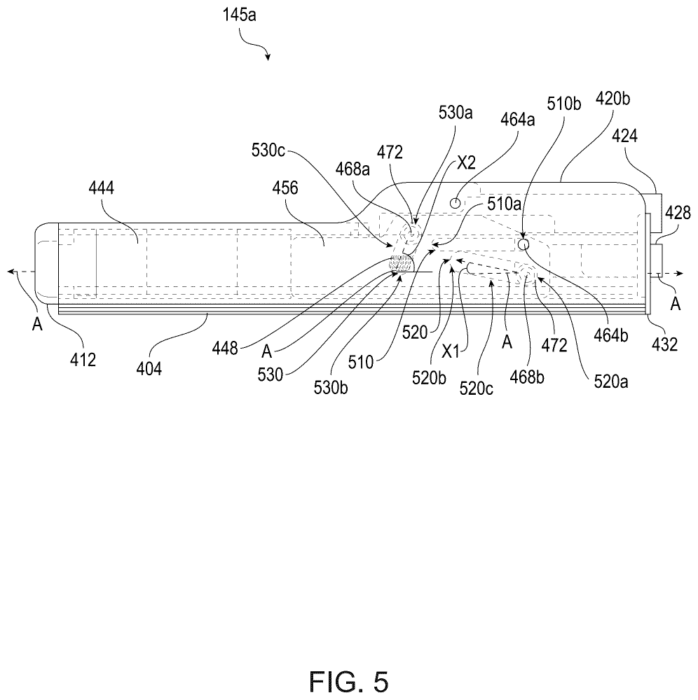

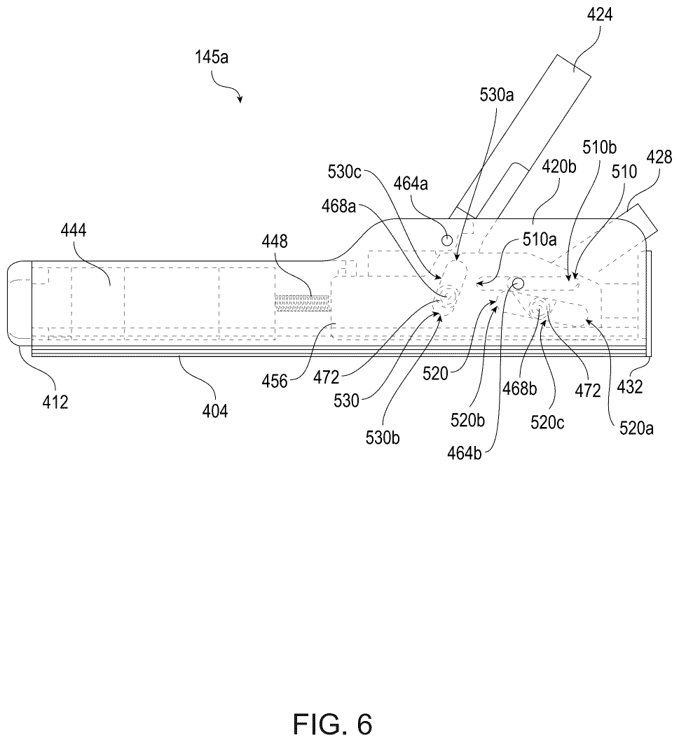

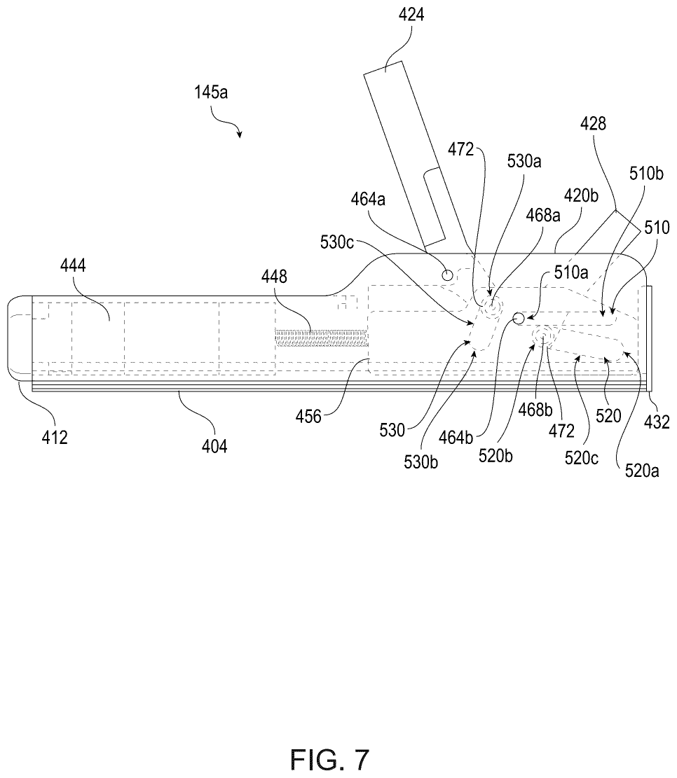

The actuator 145a may further include a first link arm 424 that includes a first end 425 and a second end 427 opposite the first end 425, and a medial portion 426 between the first and second ends 425, 427. A first aperture 429a may be defined in the medial portion 426 and a second aperture 429b may be defined in the first end 425. The second end 427 of the first link arm 424 may be fixably coupled to, or may be an extension of, the front support arm 110a (FIG. 1B) of the frame 200 (FIG. 1B). The first link arm 424 may be rotatably coupled to the housing 404 at a first pivot location 421. More specifically, the actuator 145a may include a pin 464a that can extend through the first aperture 436a of the first fin 420a, the first aperture 429a of the first link arm 424, the aperture 436d of the cover top 440, and the second aperture 436b of the second fin 420b. The first link arm 424 may be rotatable between a first or “stowed” position, as shown in FIG. 5, a second or “intermediate” position, as shown in FIG. 6, and a third or “deployed” position, as shown in FIG. 7.

The first and second positions of the first link arm 424 may be radially offset by a first angle. For instance, the first link arm 424 may rotate a first angle from the first position to reach the second position. The first angle may be less than 90°, such as 30°, 45°, 50°, 60°, 75°, or 80°, as examples. However, other embodiments are envisioned where the first angle is about 90° or greater than 90°. The first and third positions of the first link arm 424 may be radially offset by a second angle greater than the first angle. For instance, the first link arm 424 may rotate a second angle from the first position to reach the third position. The second angle may be greater than 90°, such as 95°, 100°, or 110°, as examples. However, other embodiments are envisioned where the first angle is about 90° or less than 90°.

The actuator 145a may further include a second link arm 428 that includes a first end 431 and a second end 433 opposite the first end 431. First and second apertures 435a, 435b may be defined in the first end 431. The second end 433 of the second link arm 428 may be fixably coupled to, or may be an extension of, the rear support 105a of the frame 200. The second link arm 428 may be rotatably coupled to the housing 404 at a second pivot location 423. More specifically, the actuator 145a may include a pin 464b that can extend through the third aperture 436c of the housing 404, the first aperture 435a of the second link arm 428, and the fourth aperture 436d of the housing 404. The second link arm 428 may be rotatable between a first or “stowed” position, as shown in FIG. 5, a second or “intermediate” position, as shown in FIG. 6, and a third or “deployed” position, as shown in FIG. 7.

The first and second positions of the second link arm 428 may be radially offset by a first angle that is different (less than) the first angle between the first and second positions of the first link arm 424. For instance, the second link arm 428 may rotate a first angle from the first position to reach the second position. The first angle may be less than 90°, such as 25°, 30°, or 40°, as examples. However, other embodiments are envisioned where the second angle is about 90° or greater than 90°. The first and third positions of the second link arm 428 may be radially offset by a second angle that is different (less than) the second angle between the first and third positions of the first link arm 424. For instance, the second link arm 428 may rotate a second angle from the first position to reach the third position. The second angle may be less than 90°, such as 45°, 55°, or 65°, as examples. However, other embodiments are envisioned where the second angle is about 90° or greater than 90°.

The actuator 145 may further include a back end cap 432 to seal the back end 416 of the housing 404. The back end cap 432 may define an opening or cutout 411 to receive a portion of the first and second link arms 424, 428 when the first and second link arms 424, 428 are in their respective stowed positions. In the stowed positions, the back end cap 432 may seal the space between the back end 416 and the first and second link arms 424, 428.

The actuator 145a may further include a motor 444 that may positioned through the front end 408 and within the cavity 406 of the housing 404. The motor 444 may be a brushless direct current (DC) motor, a brushed DC motor, a linear motor, or other suitable motor, like an air motor or a hydraulic motor. The front end cap 412 may provide protection to the motor 444 within the housing 404 and may be removable to allow a user to access the motor 444 from within the housing 404.

The actuator 145a may further include a threaded drive rod or drive screw 448 that is operably coupled to the motor 444 and extends from the motor 444 along the axis A toward the back end 416 of the housing 404. The motor 444 may be energized to rotate the threaded drive rod 448. The drive rod 448 may define threads that are threadably couplable with a drive nut 452. Rotation of the rod 448 may cause the nut 452 to move/translate along the length of the rod 448. For instance, the motor 444 may be energized to rotate the rod 448 in a first radial direction (e.g., clockwise) to translate the nut 452 in a first linear direction along the axis A (e.g., toward the motor 444) or rotate the rod 448 in a second radial direction (e.g., counterclockwise) opposite the first radial direction to translate the nut 452 in a second linear direction along the axis A (e.g., away from the motor 444) opposite the first linear direction.

The actuator 145a may further include a drive block or “carriage” 456 arranged within the cavity 406 of the housing 404. The drive block 456 may have a forepart or first end 460 to face the motor 444 when assembled within the housing 404. The forepart 460 may define a bore 461 to receive the drive rod 448. The drive block 456 may define a slot 453 sized to receive and linearly and radially restrain the drive nut 452. Accordingly, rotation of the drive rod 448 may linearly translate the drive nut 452 and, thus, the drive block 456, through the cavity 406. The motor 444 may drive the drive block 456 between a first or “retracted” position, as shown in FIG. 5, a second or “intermediate” position, as shown in FIG. 6, and a third or “extended” position, as shown in FIG. 6, with the second position being located between (intermediate) the first and third positions. The retracted position of the drive block 456 may correspond to the stowed positions of the first and second link arms 424, 428. The intermediate position of the drive block 456 may correspond to the intermediate positions of the first and second link arms 424, 428. The extended position of the drive block 456 may correspond to the deployed positions of the first and second link arms 424, 428. In other embodiments, the nut 452 may be integrally formed with the drive block 456.

In the retracted position of the drive block 456 and, thus, the stowed positions of the first and second link arms 424, 428 (FIG. 5), the first and second link arms 424, 428 may be parallel or at least substantially parallel, to one another and the axis A. In the intermediate position of the drive block 456 and, thus, the intermediate positions of the first and second link arms 424, 428 (FIG. 6), the first and second link arms 424, 428 may be angularly offset one another by a first angle. In the extended position of the drive block 456 and, thus, the deployed positions of the first and second link arms 424, 428 (FIG. 6), the first and second link arms 424, 428 may be angularly offset one another by a second angle that is greater than the first angle between the first and second link arms 424, 428 in the intermediate position. Due to the configuration of the drive block 456, explained in more detail below, as the drive block 456 moves from the retracted position toward the extended position, the drive block 456 may rotate the first link arm 424 at a first rate and the second link arm 428 at a second rate slower than the first rate. Accordingly, as the drive block 456 moves from the retracted position toward the extended position, an angle defined between the first and second link arms 424, 484 may progressively increase.

The drive block 456 may define, or otherwise provide, a pair of fins 481. A channel 480 may be defined between the fins 481 that is sized to receive the first end 425 of the first link arm 424 and the first end 431 of the second link arm 428 therebetween. The drive block 456 may further define a first channel 510 sized to receive the pin 464b. Accordingly, further to the above, the pin 464b may extend through the third aperture 436c of the housing 404, the first aperture 435a of the second link arm 428, the first channel 510 of the drive block 456, and the fourth aperture 436d of the housing 404. The first channel 510 may parallel, or at least substantially parallel, with the axis A.

The first channel 510 may provide a linear track for the second pin 464b as the motor 444 translates the drive block 456 between the first, second, and third positions thereof. The first channel 510 may include a first end 510a and a second end 510b opposite the first end 510a. The first and second ends 510a,b may serve as hard stops to prevent the drive block 456 from moving beyond the first and third positions thereof. For instance, as shown in FIG. 5, the pin 464b may abut the second end 510b in the first position of the drive block 456 to prevent further translation of the drive block 456 toward the motor 444. Similarly, as shown in FIG. 7, the pin 464b may abut the first end 510a in the third position of the drive block 456 to prevent further translation of the drive block 456 away the motor 444. Accordingly, the length of the first channel 510 may define the length of travel of the drive block 456 within the housing 404.

The drive block 456 may further define a second channel 520 that may be angled in a first radial direction (e.g., downwardly) relative to the first channel 510 toward the back end 416 of the housing 404 such that a non-zero angle is defined therebetween. The angle may be greater than 0° and less than 45°, such as 5°, 10°, 15°, 20°, or 25°. With reference to FIG. 5, the second channel 520 may be oriented at an angle X1 relative to the axis A.

The actuator 145a may further include a second pin 468b that can extend through the second aperture 435b of the second link arm 428 and the second channel 520 of the drive block 456. The actuator 145a may further include a pair of roller bearings 472 provided on the opposite ends of the second pin 468b. The second channel 520 may be sized to receive the second pin 468b and the roller bearings 472.

The second pin 468b and the roller bearings 472 may co-operatively function to rotate the second link arm 428 as the drive block 456 moves between the first and third positions. More specifically, with reference to FIG. 5, the second channel 520 includes a first end 520a and a second end 520b opposite the first end 510a. The ends 520a,b may serve as hard stops for the roller bearings 472 to prevent the drive block 456 from moving beyond the first and third positions thereof.

In the first position of the drive block 456 (FIG. 5), the roller bearings 472 may abut the first end 520a of the second channel 520. The roller bearings 472 abutting the first end 520a of the second channel 520 may correspond to the stowed position of the second link arm 428. As the motor 444 translates the drive carriage 456 toward the extended position, the roller bearings 472 may engage and slide along a cam wall 520c of the second channel 520, thereby causing the second link arm 428 to rotate about the second pin 464b (counterclockwise, as shown in FIGS. 5-7) and through the opening 419 of the housing 404. The first and second fins 420a,b may guide the first link arm 424 as it rotates through the opening 419. The roller bearings 472 may abut the second end 520b of the second channel 520 to prevent further rotation of the second link arm 428 in the third position of the drive block 456. The roller bearings 472 abutting the second end 520b of the second channel 520 may correspond to the deployed position of the second link arm 428.

The drive block 456 may further define a third channel 530 that may be angled in a second radial direction (e.g., upwardly) different (opposite) than the first radial direction of the second channel 520 and relative to the first channel 510 toward the back end 416 of the housing 404 such that a non-zero angle is defined therebetween. The angle may be greater than 0° and less than 90°, such as 45°, 60°, 75°, 80°, or 85°. With reference to FIG. 5, the third channel 530 may be oriented an angle X2 relative to the axis A. The angle X2 may be greater than the angle X1.

The actuator 145a may further include a first pin 468a that can extend through the second aperture 429b of the first link arm 424 and the third channel 530 of the drive block 456. The actuator 145a may further include a pair of roller bearings 472 provided on the opposite ends of the pin 468a. The third channel 530 may be sized to receive the first pin 468a and the roller bearings 472.

The first pin 468a and the roller bearings 472 may co-operatively function to rotate the first link arm 424 as the drive block 456 moves between the first and third positions thereof. More specifically, with reference to FIG. 5, the third channel 530 includes a first end 530a and a second end 530b opposite the first end 530a. The ends 530a,b may serve as hard stops for the roller bearings 472 to prevent the drive block 456 from moving beyond the first and third positions thereof.

In the retracted position of the drive block 456 (FIG. 5), the roller bearings 472 may abut the first end 530a of the third channel 530. The roller bearings 472 abutting the first end 530a of the third channel 530 may correspond to the stowed position of the first link arm 424. As the motor 444 translates the drive carriage 456 toward the extended position, the roller bearings 472 may engage and slide along a cam wall 530c of the third channel 530, thereby causing the first link arm 424 to rotate about the first pin 464a (counterclockwise, as shown in FIGS. 5-7) and through the opening 419 of the housing 404. The first and second fins 420a,b may guide the first link arm 424 as it rotates through the opening 419. The roller bearings 472 may abut the second end 530b of the third channel 530 to prevent further rotation of the first link arm 424. The roller bearings 472 abutting the second end 530b of the third channel 530 may correspond to the deployed position of the first link arm 424.

Accordingly, the actuators 145a,b enable a user of the boat 130 to actively drive both the front support arms 110a,b and rear support arms 105a,b via the first and second link arms 424, 428 of the actuators 145a,b to transition the bimini top 100 between a stowed position and a deployed position.

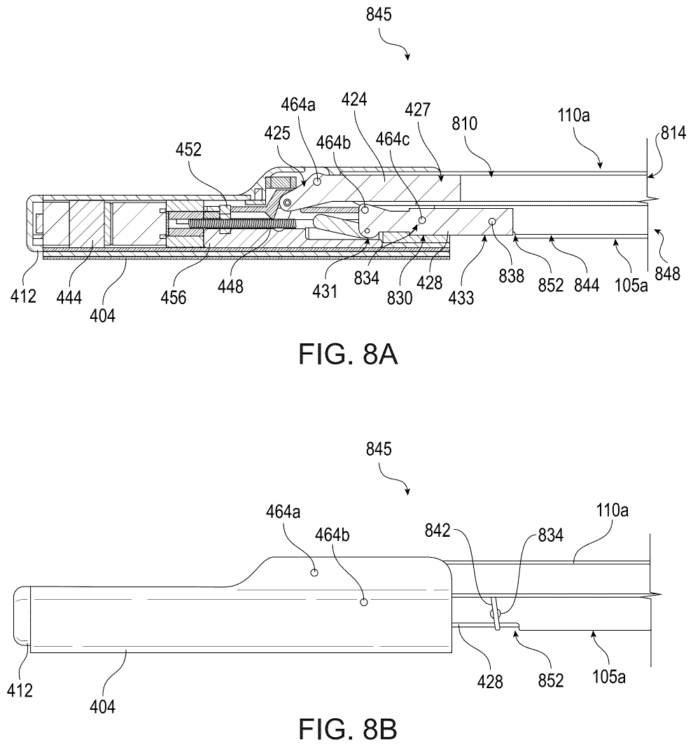

FIGS. 8A and 8B illustrate side views of an another actuator 845 for use with the frame 200, according to at least one aspect of the present disclosure. The actuator 845 may be similar in some respects to the actuators 145a,b and therefore may be best understood with reference thereto, where like numbers used in the figures correspond to similar components not described again in detail. A pair of actuator 845 may be used on boat 130 in lieu of actuators 145a,b.

As illustrated, the second end 427 of the first link arm 424 may be fixably attached to the front support arm 110a. The front support arm 110a may have a front support arm body 810 that defines a cavity 814 that may receive at least a portion of the second end 427 of the first link arm 424. The front support arm 110a may be welded to the first link arm 424 based on the second end 427 of the first link arm 424 being received in the cavity 814. Alternatively, the second end 427 of the first link arm 424 may be bolted or fastened to the front support arm 110a.

The second link arm 428 may further include a medial portion 830 between the first end 431 and the second end 433 thereof. The medial portion 830 may define a first aperture 834 and the second end 433 may define a second aperture 838. The rear support arm 105a may include a rear support arm body 844 that defines a cavity 848 that may receive at least a portion of the second end 433 of the second link arm 428. The rear support arm 105a may further define a first aperture (not shown) that may align with the first aperture 834 of the medial portion 830 based on the second end 433 of the second link arm 428 being received in the cavity 848. A pin 464c may be positioned through the first aperture 834 of the medial portion 830 and the first aperture of the rear support arm 105a to rotatably couple the second link arm 428 and the rear support arm 105a.

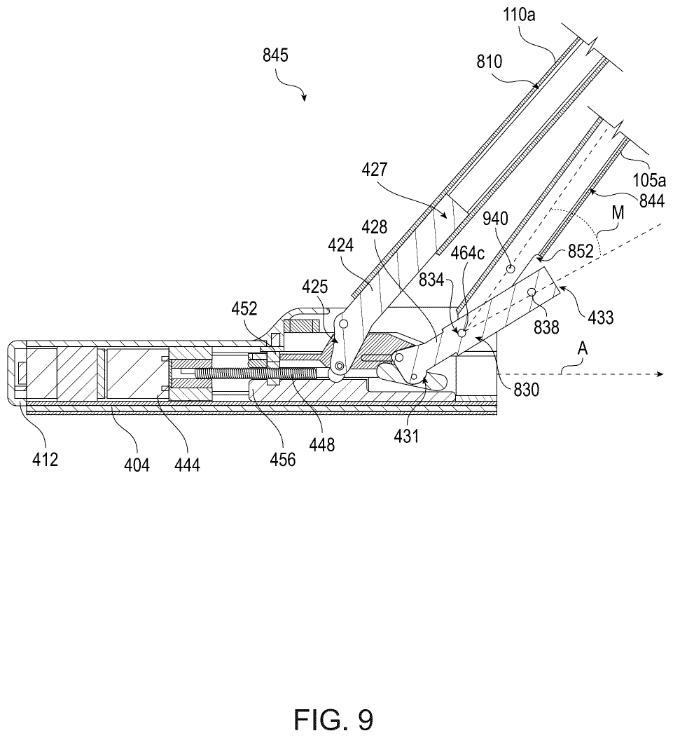

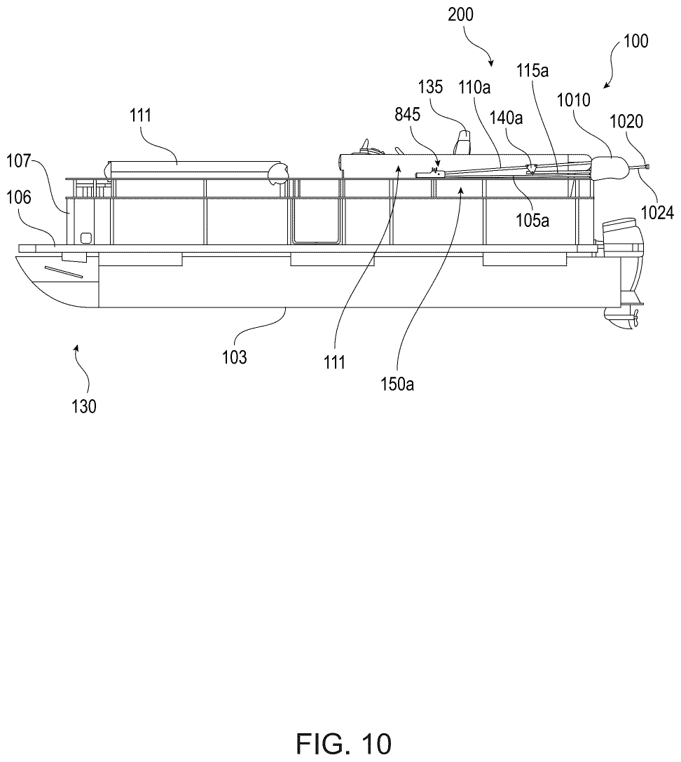

The rear support arm 105a may further define a second aperture 940 (FIG. 9) that may align with the second aperture 838 of the second end 433 based on the second end 433 of the second link arm 428 being received in the cavity 848. The rear support arm 105a may further define an opening 852. A locking pin 842 may be removably positioned through the second aperture 838 of the second end 433 and the second aperture 940 of the rear support arm 105a. Insertion of the locking pin 842 through the apertures 838, 940 may prevent the rear support arm 105a from rotating relative to the second link arm 428 about the pin 464c. Accordingly, the presence of the locking pin 842 through the apertures 838, 940 may cause the actuator 845 to function in a substantially similar manner to the actuator 145a, described elsewhere herein. More specifically, with the locking pin 842 inserted through the apertures 838, 940, rotation of the second link arm 428 may cause corresponding rotation of the rear support arm 105a, similar to what is shown in FIGS. 5-7, thereby allowing the bimini top 100, with actuators 845 coupled to rear support arms 105a,b and front support arms 110a,b, to transition between the stowed position (FIG. 10) and the deployed position (FIG. 3).

FIG. 10 illustrates a port side view of the boat 130 including the bimini top 100 in a stowed position and coupled to a pair of actuators 845 (starboard side actuator 845 hidden from view) via the frame 200. A stern light 1020 may be mounted, or otherwise connected, to the bimini top 100 via a shaft 1024. The stern light 1020 may extend from a portion of the frame 200, such as the front, middle, or rear supports 210, 215, 205, through cover 120, or may extend from the cover 120.

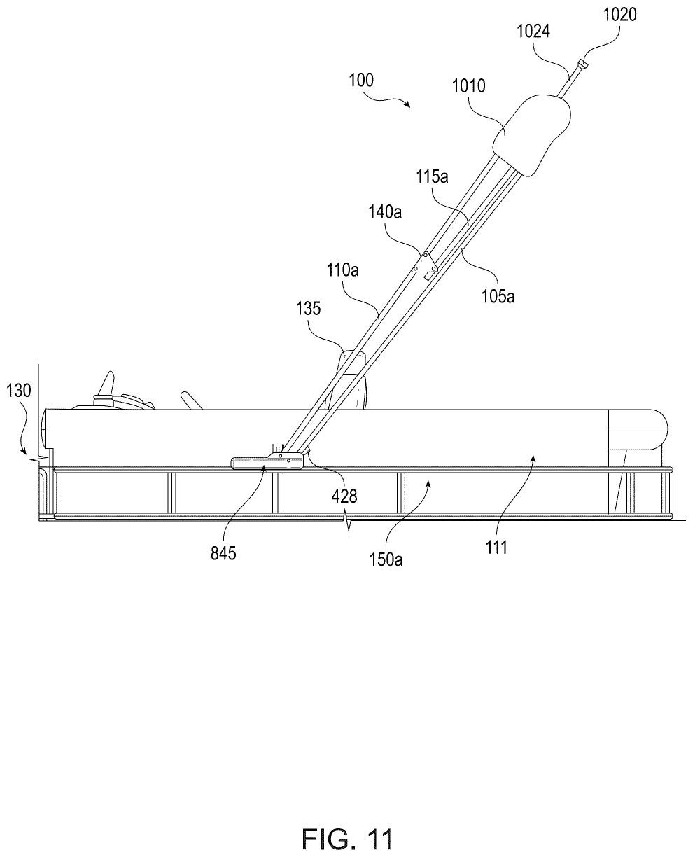

The configuration of the actuators 845 allows the bimini top 100 to transition between the stowed position (FIG. 10) and a deployed position (FIG. 1A), and further into a radar position (FIG. 11). More specifically, the cover 120 (FIG. 1B) of the bimini top 100 may be covered in a cover or wrap 1010, which may be similar to cover 121. Inclusion of the cover 1010 may couple the front support arms 110a,b and the rear support arms 105a,b together such that movement of the front support arms 110a,b causes corresponding movement of the rear support arms 105a,b. The cover 1010 may be a sheet of material (e.g., a rectangular sheet of material) that includes at least one zipper that allows the sheet of material to be attached to each other to transform the sheet of material into a tubular shape (or sleeve) around the cover 120.

When a user desires to transition the bimini top 100 to the radar position (shown in FIG. 11), the user may remove the locking pins 842 from the apertures 838, 940 of each actuator 845 (port and starboard side actuators 845). With reference to FIGS. 9 and 11, with the locking pins 842 absent from the apertures 838, 940, the front support arms 110a,b may apply a force (“forward” pulling force) to the rear support arms 105a,b via the cover 1010 as the front support arms 110a are rotated by the first link arms 424, described elsewhere herein. Based on the front support arms 110a,b applying a force to the rear support arms 105a,b via the cover 1010, the rear support arm 105a may rotate relative to the second link arm 428 about the pin 464c at an angle M and the second link arm 428 may rotate through the opening 852. The rotational position of the first and second link arms 424, 428 with the bimini top 100 in the radar position may be the same, or at least substantially the same, as the rotational position of the first and second link arms 424, 428 in their respective intermediate positions (see FIG. 6).

In an example use, when the boat 130 is being operated during daylight, the bimini top 100 may be placed into the deployed position (FIG. 1A) to protect its occupants from the sun. If the sun is not out during the daytime, the bimini top 100 may be placed into the stowed position (FIG. 10). Notably, however, when the bimini top 100 is in the stowed position, the stern light 1020 may not be sufficiently visible to other people outside the boat 130.

Applicable boating laws and regulations require that the stern light 1020 be illuminated and visible across an arc extending around at least a portion of the boat 130 when the boat 130 is being operated after sunset (at night/dusk) or under low visibility conditions. However, the user may not wish to transition the bimini top 100 to the deployed position, as this may occlude the occupants' view of the sky. Accordingly, a user may install the cover 1010 over the cover 120, to thereby couple the front support arms 110a,b and rear support arms 105a,b together, and remove the locking pins 842 from the actuators 845, thereby enabling a user to transition the bimini top 100 to the radar position, as shown in FIG. 11. In the radar position, the stern light 1020 may be in a sufficiently visible position that is in compliance with applicable laws and regulations without the boat being covered by the cover 120.

Accordingly, the actuators 845 enable a user of the boat 130 to actively drive both the front support arms 110a,b and rear support arms 105a,b via the first and second link arms 424, 428 to transition the bimini top 100 between a stowed position, a radar position, and a deployed position.

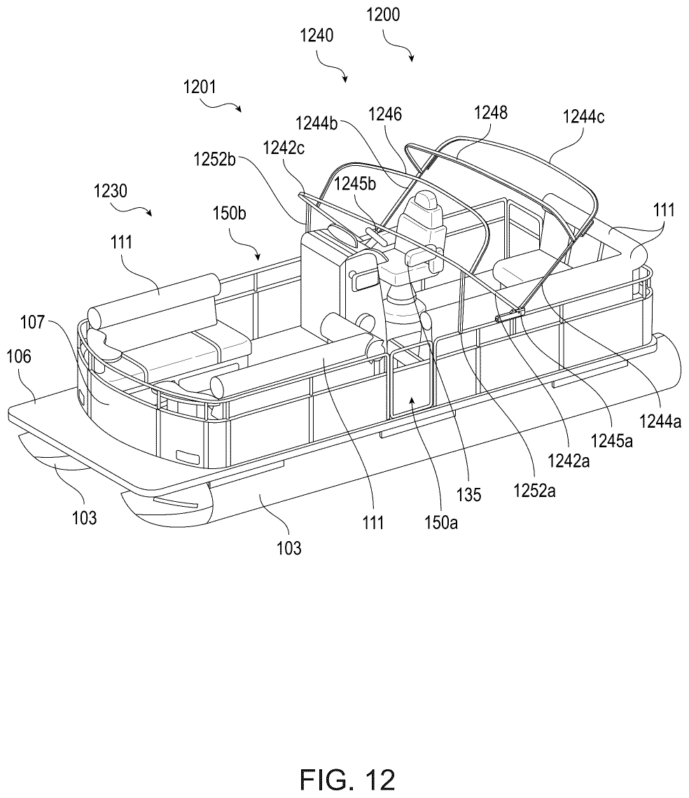

FIG. 12 is a perspective view of another boat 1230 having a system 1201 for controlling a position a bimini top 1200 of the boat 1230, according to at least one aspect of the present disclosure. The boat 1230 may be similar in some respects to the boat 130 and therefore may be best understood with reference thereto, where like numbers used in the figures correspond to similar components not described again in detail.

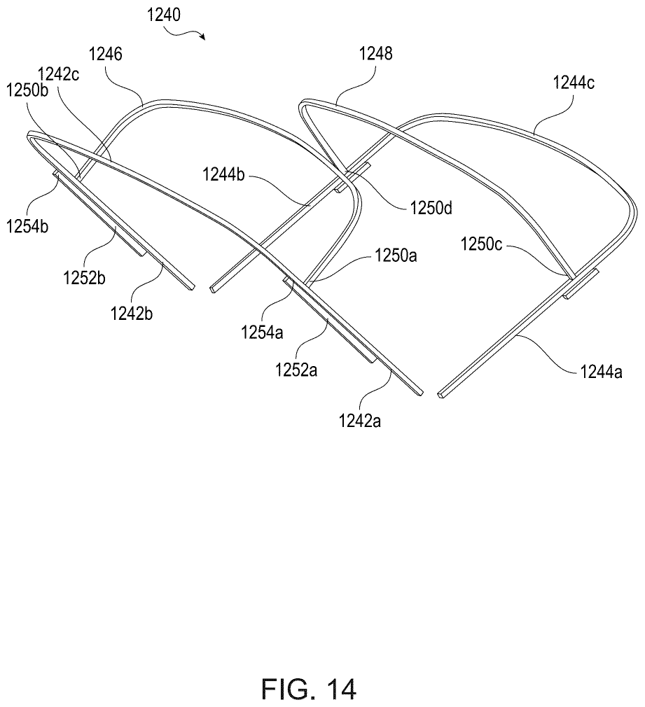

With reference to FIGS. 12 and 14, the bimini top 100 may include a frame 1240 that includes first and second front support arms 1242a, 1242b, first and second rear support arms 1244a, 1244b, a first middle support 1246, and a second middle support 1248 which collectively support a cover (not shown, but like the cover 120 (FIG. 1)) of the bimini top 1200. The front support arms 1242a,b may be coupled together via a front support member or “front support” 1242c. The front support arms 1242a,b and the front support 1242c may be of unitary construction or may be separate pieces mechanically fastened together. Similarly, the rear support arms 1244a,b can be coupled together via a rear support member or “rear support” 1244c. The rear support arms 1244a,b and the rear support 1244c may be of unitary construction or may be separate pieces mechanically fastened together.

The frame 1240 may further include first and second brackets 1250a, 1250b for coupling the first middle support 1246 to the front support arms 1242a,b and third and fourth brackets 1250c, 1250d for coupling the second middle support 1248 to the rear support arms 1244a,b. The first and second brackets 1250a,b may allow the first middle support 1246 to move relative to the front support arms 1242a,b and the third and fourth brackets 1250c,d may allow the second middle support 1248 to move relative to the rear support arms 1244a,b. The frame 1240 may further include a first frame support 1252a rotatably coupled to the first front support arm 1242a via a first bracket 1254a and a second frame support 1252b rotatably coupled to the second front support arm 1242b via a second bracket 1254b.

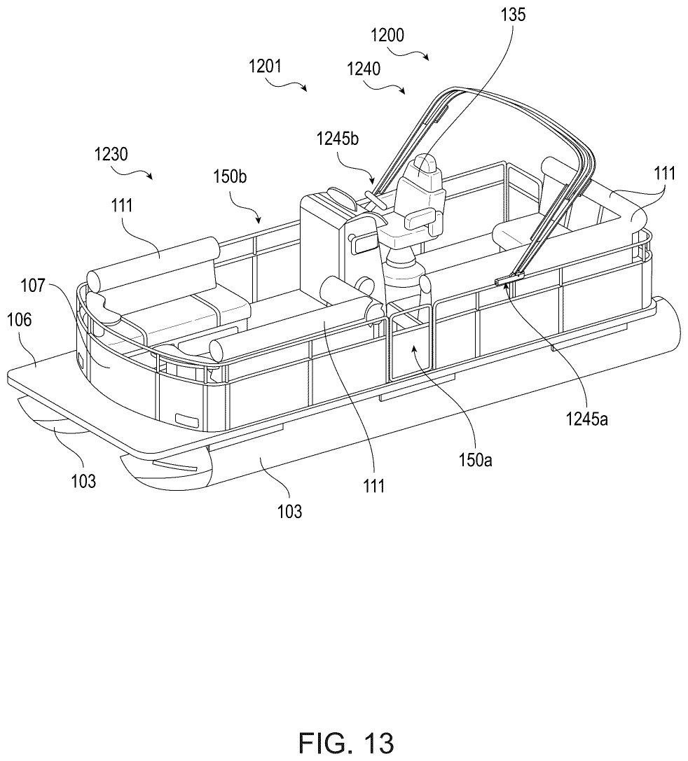

The bimini top 1200 may be transitionable between a first or “deployed” position, as shown in FIG. 12, and a second or “stowed” position, similar to the stowed position of the bimini top 100 as shown in FIG. 3, as well as a third or “radar” position, as shown in FIG. 13. In the deployed position, the cover 120 (FIG. 1) of the bimini top 1200 may provide cover from external elements (e.g., rain and/or sunlight) to occupants of the boat 1230. In addition, in the deployed position, the first and second frame support 1252a,b may be rotated away from the first and second front support arms 1242a,b, respectively, such as by gravity, to contact the first and second siderails 150a,b, respectively, thereby providing support to the frame 1240. In the stowed position, the front support arms 1242a,b, the rear support arms 1244a,b, the first and second middle supports 1246, 1248, and the first and second frame supports 1252a,b may be collapsed to a horizontal, or at least substantially horizontal position, relative to the deck 106. In the stowed position, the cover 120 (FIG. 1) of the bimini top 1200 may be covered in a sleeve, cover, or wrap, like the cover 121 (FIG. 3), to protect the cover 120. In the stowed position, the frame 1240 may surround the stern of the boat 1230. In the radar position, a stern light 1020 (FIG. 10) of the boat 1230 may be in a sufficiently visible position that is in compliance with applicable laws and regulations without the boat 1230 being covered by the cover 120 (FIG. 1).

The system 1201 may include a first or “port side” actuator 1245a and a second or “starboard side” actuator 1245b. The front and rear support arms 1242a, 1244a may be coupled to the first actuator 1245a, while the front and rear support arms 1242b, 1244b may be coupled to the second actuator 1245b, as will be described in more detail below. The first and second actuators 1245a,b may be operable to drive the front and rear support arms 1242a,b, 1244a,b to transition the bimini top 1200 between the stowed, radar, and deployed positions, as will also be described in more detail below. The first actuator 1245a may be mounted to the side rail 150a and the second actuator 1245b may be mounted to the side rail 150b. Alternatively, the actuators 1245a,b may be coupled to another part of the boat 130, such as the deck 106.

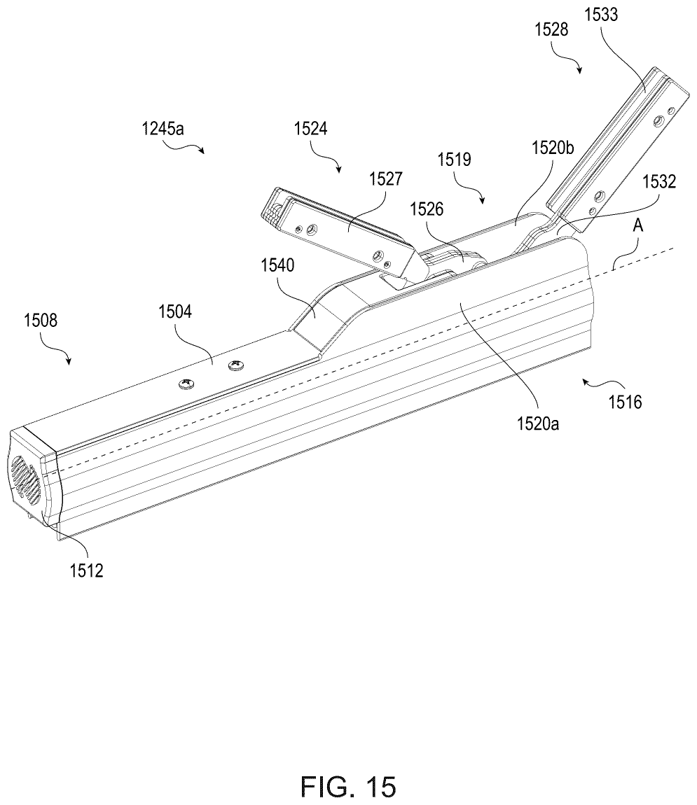

FIG. 15 is an isometric view of the first actuator 1245a, according to at least one aspect of the present disclosure. While the following discussion is provided with respect to the first actuator 1245a, the second actuator 1245b is the same, or substantially the same, construction and, thus, the following discussion is equally applicable to the second actuator 1245b.

The actuator 1245a may include a housing 1504 that includes a front end 1508 and a back end 1516 opposite the front end 1508. The housing 1504 may define a cavity, similar to cavity 406 (FIG. 4) that extends through the housing 1504 along an axis A from the front end 1508 to the back end 1516. The housing 1504 may be machined from a metal extrusion, such as aluminum, steel, titanium, or alloy. The front end 1508 of the housing 1504 may define a first or “front” opening (occluded from view) that is in communication with the cavity. A front end cap 1512 may be coupled to the housing 1504 to cover the opening, thereby protecting internal components of the actuator 1245a.

The housing 1504 may further define a second or “top” opening 1519 that is in communication with the cavity of the housing 1504. The housing 1504 may further define, or otherwise provide, first and second fins 1520a,b that extend on opposing sides of the opening 1519. The housing 1504 may include a cover top 1540 that may be arranged between at least a portion of the fins 1520a,b and coupled to the housing 1504.

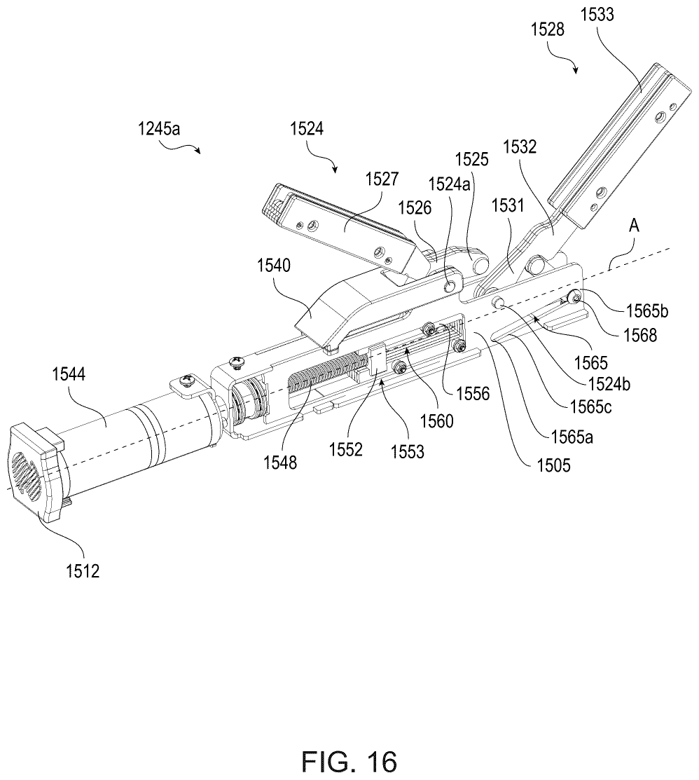

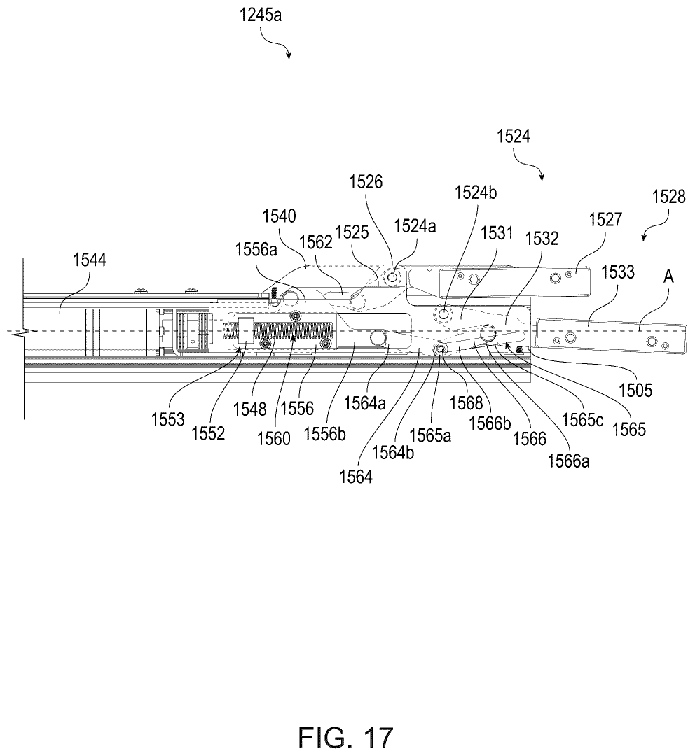

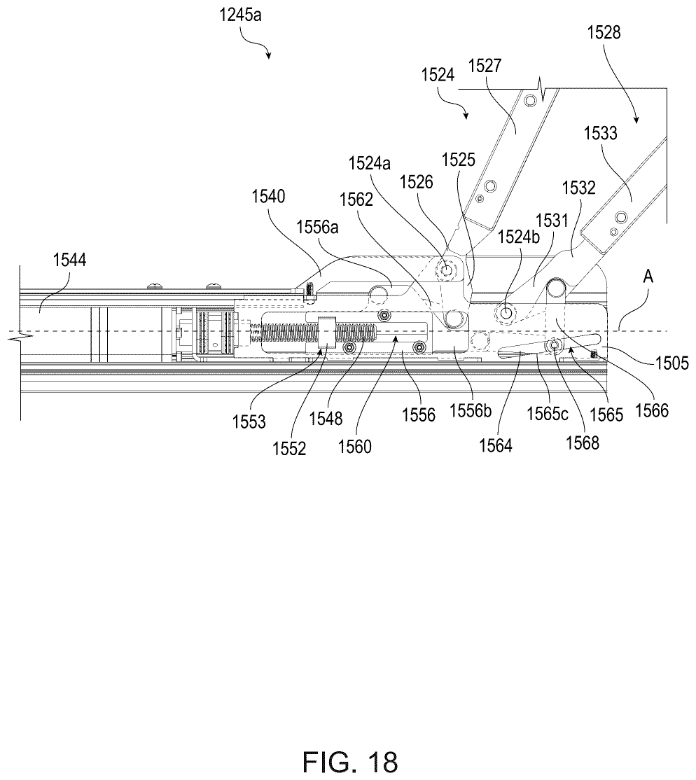

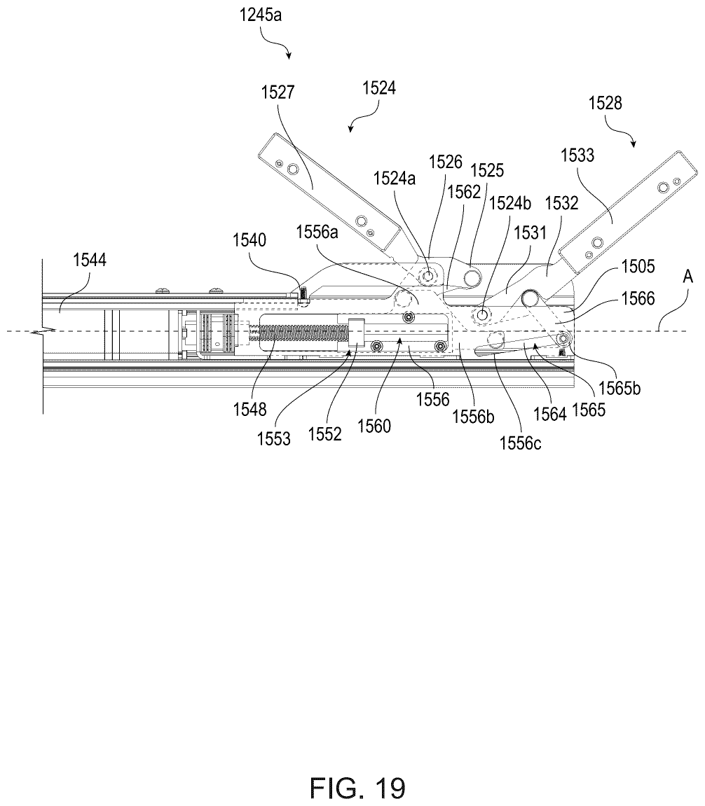

FIG. 16 is an isometric view of the first actuator 1245a omitting portions of the housing 1504 to allow for viewing of the various internal components of the first actuator 1245a. With reference to FIGS. 15 and 16, the actuator 1245a may further include a first link arm 1524 that includes a first end 1525, a second end 1527 opposite the first end 1525, and a medial portion 1526 between the first and second ends 1525, 1527. The actuator 1245a may further include a pin 1524a that may extend through apertures defined in the medial portion 1526 and the cover top 1540 to rotatably couple the first link arm 1524 to the housing 1504 via the cover top 1540. The second end 1527 of the first link arm 1524 may be fixably coupled to, or may be an extension of, the front support arm 1242a of the frame 1240. The first link arm 1524 may be rotatable between a first or “stowed” position, as shown in FIG. 17, a second or “radar” position, as shown in FIG. 18, and a third or “deployed” position, as shown in FIG. 19.

The first and second positions of the first link arm 1524 may be radially offset by a first angle. For instance, the first link arm 1524 may rotate a first angle from the first position to reach the second position. The first angle may be less than 90°, such as 70°, 75°, 80°, or 85°, as examples. However, other embodiments are envisioned where the first angle is about 90° or greater than 90°. The first and third positions of the first link arm 1524 may be radially offset by a second angle greater than the first angle. For instance, the first link arm 1524 may rotate a second angle from the first position to reach the third position. The second angle may be greater than 90°, such as 120°, 130°, or 135°, as examples. However, other embodiments are envisioned where the first angle is about 90° or less than 90°.

The actuator 1245a may further include a second link arm 1528 that includes a first end 1531, a second end 1533 opposite the first end 1531, and a medial portion 1532 between the first and second ends 1531, 1533. The second end 1533 of the second link arm 1528 may be fixably coupled to, or may be an extension of, the rear support arm 1244a of the frame 1240. The second link arm 1528 may be rotatable between a first or “stowed” position, as shown in FIG. 17, a second or “radar” position, as shown in FIG. 18, and a third or “deployed” position, as shown in FIG. 19. As further described herein, both the first link arm 1524 and the second link arm 1528 are both driven, independently of each other, to move the frame 1240 and the cover thereon between the first (stowed) position, the second (radar) position, and the third (deployed) position.

The actuator 1245a may further include a frame 1505 disposed within the cavity of the housing 1504. The actuator 1245a may further include a pin 1524b that may extend through apertures defined in the first end 1531 of the second link arm 1528 and the frame 1505 to rotatably couple the second link arm 1528 to the housing 1504 via the frame 1505. The frame 1505 may define a channel or slot 1565 that may be angled relative to the axis A (e.g., “upwardly”) such that a non-zero angle is defined therebetween. The angle may be greater than 0° and less than 90°, such as 5°, 10°, or 15°. The slot 1565 may include a first end 1565a and a second end 1565b opposite the first end 1565a.

The first and second positions of the second link arm 1528 may be radially offset by a first angle that is the same as, or similar to, the first angle between the first and second positions of the first link arm 1524. For instance, the second link arm 1528 may rotate a first angle from the first position to reach the second position. The first angle may be less than 90°, such as 70°, 75°, 80°, or 85°, as examples. However, other embodiments are envisioned where the first angle is about 90° or greater than 90°. The first and third positions of the second link arm 1528 may be radially offset by a second angle that is different (less than) the second angle between the first and third positions of the first link arm 1524. For instance, the second link arm 1528 may rotate a second angle from the first position to reach the third position. The second angle may be less than 90°, such as 45°, 55°, or 65°, as examples. However, other embodiments are envisioned where the second angle is about 90° or greater than 90°.

As will be described in more detail below, with reference to FIGS. 17 and 18, to rotate from the first position to the second position, the second link arm 1528 may rotate in a first radial direction (e.g., counterclockwise, as viewed in FIGS. 17 and 18). Conversely, with reference to FIGS. 18 and 19, to rotate from the second position to the third position, the second link arm 1528 may rotate in a second radial direction (e.g., clockwise, as viewed in FIGS. 18 and 19) opposite the first radial direction.

The actuator 1245a may further include a motor 1544 that may positioned through the front end 1508 and within the cavity of the housing 1504. The motor 1544 may be a brushless direct current (DC) motor, a brushed DC motor, a linear motor, or other suitable motor, like an air motor or a hydraulic motor. The front end cap 1512 may provide protection to the motor 1544 within the housing 1504 and may be removable to allow a user to access the motor 1544 from within the housing 1504.

The actuator 1245a may further include a threaded drive rod or drive screw 1548 that is operably coupled to the motor 1544 and that extends from the motor 1544 toward the back end 1516 of the housing 1504. The motor 1544 may be energized to rotate the threaded drive rod 1548. The drive rod 1548 may define threads that are threadably couplable with a drive nut 1552. Rotation of the rod 1548 may cause the nut 1552 to move/translate along the length of the rod 1548. For instance, the motor 1544 may be energized to rotate the rod 1548 in a first radial direction (e.g., clockwise) to translate the nut 1552 in a first linear direction (e.g., toward the motor 1544) or rotate the rod 1548 in a second radial direction (e.g., counterclockwise) opposite the first radial direction to translate the nut 1552 in a second linear direction (e.g., away from the motor 1544) opposite the first linear direction.

The actuator 1245a may further include a drive block or “carriage” 1556 arranged within the cavity of the housing 1504. The drive block 1556 may define a first notch 1560 that may be sized to receive the drive rod 1548 (see FIG. 17). The drive block 1556 may define a second notch 1553 sized to receive and linearly and radially restrain the drive nut 1552, such that the drive block 1556 will move/translate with the nut 1552 in response to rotation of the rod 1548. Accordingly, rotation of the drive rod 1548 may linearly translate the drive nut 1552 and, thus, the drive block 1556, within the housing 1504. The motor 1544 may drive the drive block 1556 between a first or “retracted” position, as shown in FIG. 17, a second or “intermediate” position, as shown in FIG. 18, and a third or “extended” position, as shown in FIG. 19, with the second position being located between (intermediate) the first and third positions. The retracted position of the drive block 1556 may correspond to the stowed positions of the first and second link arms 1524, 1528. The intermediate position of the drive block 1556 may correspond to the intermediate positions of the first and second link arms 1524, 1528, from which the bimini top may be moved into the radar position. The extended position of the drive block 1556 may correspond to the deployed positions of the first and second link arms 1524, 1528. In other embodiments, the nut 1552 may be integrally formed with the drive block 1556.

In the retracted position of the drive block 1556 and, thus, the stowed positions of the first and second link arms 1524, 1528 (FIG. 17), the first and second link arms 1524, 1528 may be substantially parallel to one another and the axis A. In the intermediate position of the drive block 1556 and, thus, the intermediate positions of the first and second link arms 1524, 1528 (FIG. 18), the first and second link arms 1524, 1528 may be parallel to one, or slightly angularly offset one another by a first angle, such as 5°, 10°, or 15°, and angled relative to the axis A at a non-zero angle. In the extended position of the drive block 1556 and, thus, the deployed positions of the first and second link arms 1524, 1528 (FIG. 19), the first and second link arms 1524, 1528 may be angularly offset one another by a second angle that is greater than the first angle between the first and second link arms 1524, 1528 in the intermediate position of the drive block 1556.

Due to the configuration of the arrangement of the actuator 1245a, explained in more detail below, as the drive block 1556 moves from the retracted position to the intermediate position (FIG. 17 to FIG. 18), the first and second link arm 1524, 1528 may rotate in a first radial direction (e.g., counterclockwise, as viewed in FIGS. 17 and 18) and an angle may be defined therebetween at a first rate. As the drive block 1556 moves from the intermediate position to the extended position (FIG. 18 to FIG. 19), the first and second link arm 1524 may rotate away from one another. More specifically, as the drive block 1556 moves from the intermediate position to the extended position, the first link arm 1524 may continue to rotate in the first radial direction, while the second link arm 1528 may transition to rotating in a second radial direction (e.g., clockwise, as viewed in FIGS. 18 and 19) that is opposite the first radial direction. Accordingly, as the drive block 1556 moves from the intermediate position toward the extended position, an angle between the first and second link arms 1524, 1528 may be defined therebetween at a second rate greater than the first rate.

With reference now to FIG. 17, the drive block 1556 may define, or otherwise provide, a first extension 1556a and the actuator 1245a may further include a first link 1562 pivotably coupled to both the first extension 1556a and the first end 1525 of the first link arm 1524. As the drive block 1556 moves toward the extended position, the drive block 1556 may push the first link 1562, thereby rotating the first link arm 1524 about the pin 1524a in a first radial direction (e.g., counterclockwise, as viewed in FIG. 17). Conversely, as the drive block 1556 moves toward the retracted position, the drive block 1556 may pull the first link 1562, thereby rotating the first link arm 1524 about the pin 1524a in a second radial direction (e.g., clockwise, as viewed in FIG. 17) opposite the first radial direction.

The drive block 1556 may further define, or otherwise provide, a second extension 1556b. The actuator 1245a may further include a second link 1564 and a third link 1566. A first end 1564a of the second link 1564 may be pivotably coupled to the second extension 1556b and a first end 1566a of third link 1566 may be pivotably coupled to the medial portion 1532 of the second link arm 1528. The actuator 1245a may further include a pin 1568 that may extend through an aperture define in a second end 1564b of the second link 1564, an aperture in a second end 1566b of the third link 1566, and the slot 1565.

The first and second ends 1565a,b of the slot 1565 may serve as hard stops for the pin 1568 within the slot 1565. For instance, as shown in FIG. 17, the pin 1568 may abut the first end 1565a in the first position of the drive block 1556 to prevent further translation of the drive block 1556 toward the motor 1544. Similarly, as shown in FIG. 16 and FIG. 19, the pin 1568 may abut the second end 1565b in the third position of the drive block 1556 to prevent further translation of the drive block 1556 away from the motor 1544. Accordingly, the length of the slot 1565 may define the length of travel of the drive block 1556 within the housing 1504.

As the drive block 1556 moves toward the extended position, the drive block 1556 may push the second link 1564, causing the pin 1568 to translate within the slot 1565 toward the second end 1565b. The pin 1568 may engage a cam wall 1565c of the frame 1505, causing the third link 1566 to rotate in a first radial direction (e.g., counterclockwise, as viewed in FIG. 17) toward a vertical orientation, perpendicular to the axis A, as exemplified in FIG. 18. As the third link 1566 rotates toward the vertical orientation, the third link 1566 may “lift” the second link arm 1528, causing the second link arm 1528 to rotate about the pin 1524b in a first radial direction (e.g., counterclockwise, as viewed in FIG. 17 and FIG. 18).

Once the pin 1568 has rotated the third link 1566 to the vertical orientation (FIG. 18), continued movement of the pin 1568 toward the second end 1565b of the slot 1565 may cause the third link 1566 to continue to rotate in the first radial direction (e.g., counterclockwise, as viewed in FIG. 17 and FIG. 18) toward the axis A. As the third link 1566 continues to rotate in the first radial direction toward the axis A from the vertical orientation, the third link 1566 may “pull” the second link arm 1528, causing the second link arm 1528 to rotate about the pin 1524b in a second radial direction (e.g., clockwise, as viewed in FIG. 17) opposite the first radial direction to reach the deployed position thereof, as exemplified in FIG. 19.

In an example use, when the boat 1230 is being operated during daylight, the bimini top may be placed into the deployed position (FIG. 12) to protect its occupants from the sun. If the sun is not out during the daytime, the bimini top may be placed into the stowed position (similar to FIG. 3). Notably, however, when the bimini top is in the stowed position, a stern light of the boat 1230 (like stern light 1020) may not be sufficiently visible to other people outside the boat 1230.

Applicable boating laws and regulations require that the stern light be illuminated and visible across an arc extending around at least a portion of the boat 130 when the boat 1230 is being operated after sunset (at night/dusk) or under low visibility conditions. However, the user may not wish to transition the bimini top to the deployed position, as this may occlude the occupants' view of the sky. Accordingly, a user may transition the bimini top to the radar position, as shown in FIG. 13. In the radar position, the stern light may be in a sufficiently visible position that is in compliance with applicable laws and regulations without the boat being covered by the canvas.

Accordingly, the actuators 1245a,b enable a user of the boat 1230 to actively drive both the front support arms 1242a,b and rear support arms 1244a,b via the first and second link arms 1524, 1528 to transition the bimini top 1200 between a stowed position, a radar position, and a deployed position.

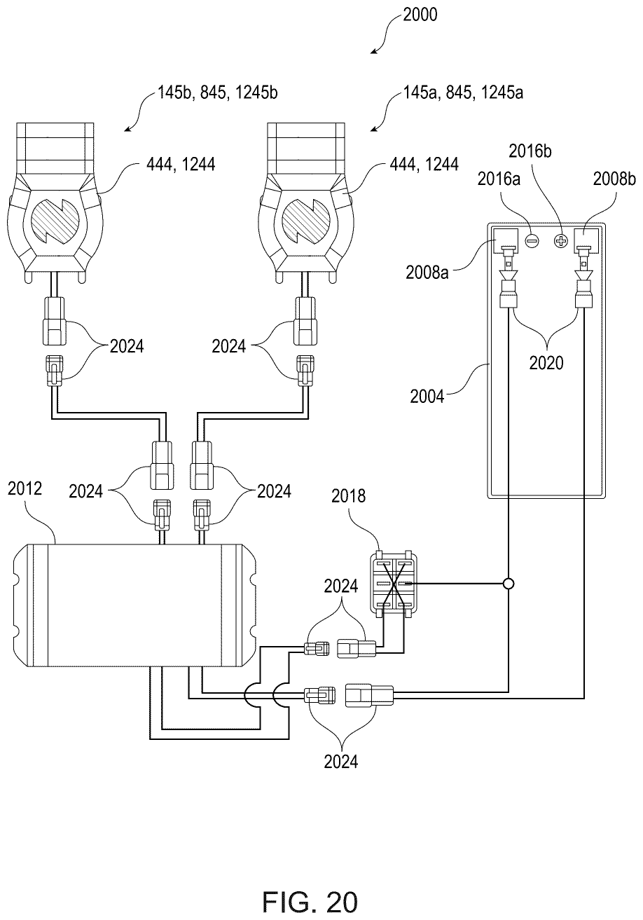

FIG. 20 illustrates a control system 2000 that is operable to control the actuators 145a,b, 845, 1245a,b disclosure herein, according to at least one aspect of the present disclosure. The control system 2000 may include a motor controller 2012 and a power supply 2004, such as a battery, that includes first and second outputs 2008a, 2008b that can be provided to the motor controller 2012. The first output 2008a may be a ground or negative line and the second output 2008b may be an energized or positive line. The power supply 2004 may further include first and second indicators 2016a, 2016b that may correspond to the first and second outputs 2008a,b, respectively. The first indicator 2016a may indicate that the first output 2008a is the ground or negative power line and the second indicator 2016b may indicate that the second output 2008b is the positive or hot power line.

The first and second outputs 2008a,b may travel through corresponding terminal connectors 2020 that are arranged between the outputs 2008a,b and the motor controller 2012. The terminal connectors 2020 may be crimps on cable eyelets. Cables may be provided from the outputs 2008 to the motor controller 2012. Adapters 2024 may also be provided to connect various components of the control system 2000.

A switch 2018 may be provided to control the position of the bimini top via the actuators 145a,b, 845, 1245a,b. The motors of the actuators 145a,b, 845, 1245a,b may be energized by the power supply 2004 based on a user providing an input to the switch 2018.

The switch 2018 may include a first button and a second button. Depressing the first button may cause the motor controller 2012 to energize the motors of both actuators (port and starboard side actuators) via the power supply 2004 to synchronously rotate the front support arms and rear support arms, as described elsewhere herein, to transition the bimini top toward the deployed position. Ceasing to depress the first button may cause the power supply 2004 to stop energizing the motors to stop driving the actuators. Alternatively, depressing the first button may cause the motor controller 2012 to energize the motors with the power supply 2004 until the bimini top reaches the radar position or the deployed position.

Depressing the second button may cause the motor controller 2012 to energize the motors of both actuators (port and starboard side actuators) via the power supply 2004 to synchronously rotate the front support arms and rear support arms, as described elsewhere herein, to transition the bimini top toward the stowed position. Ceasing to depress the second button may cause the power supply 2004 to stop energizing the motors to stop driving the actuators. Alternatively, depressing the second button may cause the motor controller 2012 to energize the motors with the power supply 2004 until the bimini top reaches the stowed position.

Alternatively, the switch 2018 may include first, second, and third buttons, where depressing the first button transitions the bimini top to the stowed position, depressing the second button transitions the bimini top to the intermediate position, and depressing the third button transitions the bimini top to the deployed position.

The motor controller 2012 may synchronize the motors with an adjustable amp limiting adjustable synchronizer, a voltage limiting adjustable control synchronizer, such as a Back Electromotive Force (EMF) controller, or a control unit that includes a memory for storing one or more preset positions, or combinations thereof. The motor controller 2012 may monitor the position of the various components of the actuators 145a,b, 845, 1245a,b via one or more sensors, such as Hall-Effect sensors and/or back electromagnetic frequency (EMF) at the motors to determine when to cease energizing the motors. Control signals from the motor controller 2012 to the motors may be pulse width modulated (PWM) signals that dictate a speed and direction of the motors within the actuators.

Accordingly, the control system 2000 enables a user of the boat 1230 to control a position of the bimini tops disclosed herein.

Embodiments disclosed herein include:

A. A bimini top comprising a frame comprising a first support arm and a second support arm and an actuator comprising a housing, a first link arm coupled to the first support arm and rotatably coupled to the housing, a second link arm coupled to the second support arm and rotatably coupled to the housing, a drive carriage movable within the housing between a first position and a second position, and a motor to drive the drive carriage between the first and second positions. The first and second link arms are rotatable relative to the housing based on the drive carriage moving between the first and second positions.

B. An actuator comprising a housing defining a cavity and an opening, a first link arm rotatably coupled to the housing, a second link arm rotatably coupled to the housing, a drive carriage movable within the cavity between a first position and a second position, a drive nut positioned in the drive carriage, and a drive screw threadably coupled to the drive nut. The first and second link arms are rotatable relative to the housing and through the opening based on the drive carriage moving between the first and second positions. The drive carriage is movable between the first and second positions based on rotation of the drive screw.

C. A boat comprising a first side rail on a port side of the boat, a second side rail on a starboard side of the boat, and a bimini top configurable between a stowed position and a deployed position. The bimini top comprises a frame comprising first and second front support arms and first and second rear support arms, a first actuator mountable to the first side rail and couplable with the first front support arm and the first rear support arm, and a second actuator mountable to the second side rail and couplable with the second front support arm and the second rear support arm. The first actuator comprises a housing, a first link arm coupled to the first front support arm and rotatably coupled to the housing, a second link arm coupled to the first rear support arm and rotatably coupled to the housing, and a drive carriage movable within the housing between a first position and a second position. The first and second link arms are rotatable relative to the housing to transition the bimini top from the stowed position toward the deployed position based on the drive carriage moving toward the second position.

Each of embodiments A-C may have one or more of the following additional elements in any combination: Element 1: wherein the drive carriage defines a first channel and the first link arm defines a first aperture, and wherein the bimini top further comprises a first pin extending within the first channel and the first aperture. Element 2: wherein the drive carriage further defines a second channel and the second link arm defines a second aperture, and wherein the bimini top further comprises a second pin extending within the second channel and the second aperture. Element 3: wherein the drive carriage is movable between the first and second positions along an axis, wherein the first channel is angled relative to the axis at a first angle, and wherein the second channel is angled relative to the axis at a second angle different than the first angle. Element 4: wherein the first angle is greater than the second angle. Element 5: wherein the first channel is angled in a first radial direction relative to the axis, and wherein the second channel is angled in a second radial direction opposite the first radial direction. Element 6: wherein the second support arm is rotatable relative to the second link arm. Element 7: where the second support arm defines a first aperture and the second link arm defines a second aperture, wherein the bimini top further comprising a locking pin, and wherein the second support arm is prevented from rotating relative to the second link arm based on the presence of the locking pin within the first and second apertures and the second support arm is allowed to rotate relative to the second link arm based on the absence of the locking pin from the first and second apertures. Element 8: further comprising a first link pivotably coupled to the drive carriage and the first link arm. Element 9: further comprising a second link pivotably coupled to the drive carriage, a third link pivotably coupled to the second link arm, and a pin pivotably coupling the second and third links. Element 10: further comprising a frame disposed in the housing and that defines a slot, and wherein the pin is movable through the slot based on the drive carriage moving between the first and second positions. Element 11: wherein the drive carriage is movable between the first and second positions along an axis, and wherein the slot is angled relative to the axis. Element 12: wherein the pin is movable within the slot between a first position, a second position, and a third position, wherein the second position is between the first and third positions, and wherein the second link arm is rotatable in a first radial direction based on the pin moving from the first position toward the second position, and the second link arm is rotatable in a second radial direction opposite the first radial direction based on the pin moving from the second position toward the third position. Element 13: wherein the drive carriage defines a first channel and a second channel, the first link arm defines a first aperture, the second link arm defines a second aperture, and the actuator further comprises a first pin extending within the first channel and the first aperture and a second pin extending within the second channel and the second aperture. Element 14: wherein the second link arm is rotatably coupled to a support arm that defines a first aperture, wherein the second link arm defines a second aperture, wherein the actuator further comprises a locking pin, and wherein the support arm is prevented from rotating relative to the second link arm based on the presence of the locking pin within the first and second apertures and the support arm is allowed to rotate relative to the second link arm based on the absence of the locking pin from the first and second apertures. Element 15: further comprising a first link pivotably coupled to the drive carriage and the first link arm, a second link pivotably coupled to the drive carriage, a third link pivotably coupled to the second link arm, and a pin pivotably coupling the second and third links. Element 16: wherein the drive carriage is movable between the first and second positions along an axis, wherein the actuator further comprises a frame disposed in the housing and that defines a slot angled relative to the axis, and wherein the pin is movable through the slot based on the drive carriage moving between the first and second positions. Element 17: wherein the pin is movable within the slot between a first position, a second position, and a third position, wherein the second position is between the first and third positions, and wherein the second link arm is rotatable in a first radial direction based on the pin moving from the first position toward the second position and the second link arm is rotatable in a second radial direction opposite the first radial direction based on the pin moving from the second position toward the third position.

By way of non-limiting example, exemplary combinations applicable to A, B, and C include: Element 1 and Element 2; Element 1 with Element 2 and 3; Element 1 with Elements 2-4; Element 1 with Elements 2, 3, and 5; Element 6 with Element 7; Element 8 with Element 9; Element 8 with Elements 9 and 10; Element 8 with Elements 9-11; Element 8 with Elements 9, 10, and 12; Element 15 with Element 16; and Element 15 with Elements 16 and 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A bimini top, comprising:
a frame comprising a first support arm and a second support arm; and
an actuator, comprising:
a housing;
a first link arm coupled to the first support arm and rotatably coupled to the housing;
a second link arm coupled to the second support arm and rotatably coupled to the housing;
a drive carriage movable within the housing between a first position and a second position, wherein the first and second link arms are rotatable relative to the housing based on the drive carriage moving between the first and second positions; and
a motor to drive the drive carriage between the first and second positions.

2. The bimini top of claim 1, wherein the drive carriage defines a first channel and the first link arm defines a first aperture, and wherein the bimini top further comprises a first pin extending within the first channel and the first aperture.

3. The bimini top of claim 2, wherein the drive carriage further defines a second channel and the second link arm defines a second aperture, and wherein the bimini top further comprises a second pin extending within the second channel and the second aperture.

4. The bimini top of claim 3, wherein the drive carriage is movable between the first and second positions along an axis, wherein the first channel is angled relative to the axis at a first angle, and wherein the second channel is angled relative to the axis at a second angle different than the first angle.

5. The bimini top of claim 4, wherein the first angle is greater than the second angle.

6. The bimini top of claim 4, wherein the first channel is angled in a first radial direction relative to the axis, and wherein the second channel is angled in a second radial direction opposite the first radial direction.

7. The bimini top of claim 1, wherein the second support arm is rotatable relative to the second link arm.

8. The bimini top of claim 7, where the second support arm defines a first aperture and the second link arm defines a second aperture, wherein the bimini top further comprising a locking pin, and wherein:
the second support arm is prevented from rotating relative to the second link arm based on the presence of the locking pin within the first and second apertures; and
the second support arm is allowed to rotate relative to the second link arm based on the absence of the locking pin from the first and second apertures.

9. The bimini top of claim 1, further comprising a first link pivotably coupled to the drive carriage and the first link arm.

10. The bimini top of claim 9, further comprising:
a second link pivotably coupled to the drive carriage;
a third link pivotably coupled to the second link arm; and
a pin pivotably coupling the second and third links.

11. The bimini top of claim 10, further comprising a frame disposed in the housing and that defines a slot, and wherein the pin is movable through the slot based on the drive carriage moving between the first and second positions.

12. The bimini top of claim 11, wherein the drive carriage is movable between the first and second positions along an axis, and wherein the slot is angled relative to the axis.

13. The bimini top of claim 11, wherein the pin is movable within the slot between a first position, a second position, and a third position, wherein the second position is between the first and third positions, and wherein:
the second link arm is rotatable in a first radial direction based on the pin moving from the first position toward the second position; and
the second link arm is rotatable in a second radial direction opposite the first radial direction based on the pin moving from the second position toward the third position.

14. An actuator, comprising:
a housing defining a cavity and an opening;
a first link arm rotatably coupled to the housing;
a second link arm rotatably coupled to the housing;
a drive carriage movable within the cavity between a first position and a second position, wherein the first and second link arms are rotatable relative to the housing and through the opening based on the drive carriage moving between the first and second positions;
a drive nut positioned in the drive carriage; and
a drive screw threadably coupled to the drive nut, wherein the drive carriage is movable between the first and second positions based on rotation of the drive screw.

15. The actuator of claim 14, wherein:
the drive carriage defines a first channel and a second channel;
the first link arm defines a first aperture;
the second link arm defines a second aperture; and
the actuator further comprises:
a first pin extending within the first channel and the first aperture; and
a second pin extending within the second channel and the second aperture.

16. The actuator of claim 14, wherein the second link arm is rotatably coupled to a support arm that defines a first aperture, wherein the second link arm defines a second aperture, wherein the actuator further comprises a locking pin, and wherein:
the support arm is prevented from rotating relative to the second link arm based on the presence of the locking pin within the first and second apertures; and
the support arm is allowed to rotate relative to the second link arm based on the absence of the locking pin from the first and second apertures.

17. The actuator of claim 14, further comprising:
a first link pivotably coupled to the drive carriage and the first link arm;
a second link pivotably coupled to the drive carriage;
a third link pivotably coupled to the second link arm; and
a pin pivotably coupling the second and third links.

18. The actuator of claim 17, wherein the drive carriage is movable between the first and second positions along an axis, wherein the actuator further comprises a frame disposed in the housing and that defines a slot angled relative to the axis, and wherein the pin is movable through the slot based on the drive carriage moving between the first and second positions.

19. The actuator of claim 18, wherein the pin is movable within the slot between a first position, a second position, and a third position, wherein the second position is between the first and third positions, and wherein:
the second link arm is rotatable in a first radial direction based on the pin moving from the first position toward the second position; and
the second link arm is rotatable in a second radial direction opposite the first radial direction based on the pin moving from the second position toward the third position.

20. A boat, comprising:
a first side rail on a port side of the boat;
a second side rail on a starboard side of the boat; and
a bimini top configurable between a stowed position and a deployed position, wherein the bimini top comprises:
a frame, comprising:
first and second front support arms; and
first and second rear support arms;
a first actuator mountable to the first side rail and couplable with the first front support arm and the first rear support arm; and
a second actuator mountable to the second side rail and couplable with the second front support arm and the second rear support arm;
wherein the first actuator comprises:
a housing;
a first link arm coupled to the first front support arm and rotatably coupled to the housing;
a second link arm coupled to the first rear support arm and rotatably coupled to the housing; and
a drive carriage movable within the housing between a first position and a second position, wherein the first and second link arms are rotatable relative to the housing to transition the bimini top from the stowed position toward the deployed position based on the drive carriage moving toward the second position.
